(19) United States
(12) Patent Application Publication
(10) Pub. No.: US 2026/0017596 A1
(43) Pub. Date: Jan. 15, 2026

(54) METHOD AND SYSTEM FOR DETERMINING AN ADAPTABILITY QUOTIENT INDEX

(71) Applicant: KnowMeQ Incorporated, Etobicoke (CA)

(72) Inventors: Matt FORAN, Etobicoke (CA); Wesley ROSE, Etobicoke (CA); Anemily MACHINA, Etobicoke (CA); Ali KOKULU, Etobicoke (CA)

(21) Appl. No.: 19/265,046

(22) Filed: Jul. 10, 2025

Related U.S. Application Data
(60) Provisional application No. 63/669,340, filed on Jul. 10, 2024.

(51) Int. Cl. G06Q 10/0639

(52) U.S. Cl. CPC G06Q 10/06398

(57) ABSTRACT

The disclosure is directed at a method and system for determining an adaptability quotient (AQ) index. The AQ index or score may be seen as a measure of an applicant's suitability for an employment opportunity or an applicant's suitability for a specific employment field. The AQ index may also reflect an applicant's ability to adjust to changes in work conditions and adapt to new tasks or situations. The AQ score may be used to determine which individuals may be most suited for a specific type of employment or to determine which individuals may be more suited for a job opening.

### CROSS-REFERENCE TO OTHER APPLICATIONS

The disclosure claims priority from U.S. Provisional Patent Application No. 63/669,340 filed Jul. 10, 2024, which is hereby incorporated by reference.

### FIELD

The disclosure is generally directed at the field of human resources, and more specifically, at a method and system for determining an adaptability quotient (AQ) index or score.

### BACKGROUND

For human resource departments in different organizations, there is always a premium with respect to hiring the correct individual for an open position. There have been many solutions and methodologies that have been created and that are currently being used by different organizations to determine the best qualified candidates for a position. As the job market continues to grow, there is an on-going need to focus on the hiring process and the recruitment of talent. In making a determination with respect to suitability, human resource individuals may use different markers to rank candidates. In making these determinations, quantifying the skills match and determining how a candidate may adapt to a position of employment should be considered.

In order to find the right person for the job, hiring managers typically have to review many resumes that are submitted by applicants seeking employment. This can be very time consuming as these hiring managers (or other hiring personnel) need to review the resumes of all applicants whether they are suitable for the position or not. This may result in a time-consuming process to review submissions from unsuitable candidates.

Therefore, there is provided a novel method and system for determining an adaptability quotient index which may assist in determining suitable applicants for a position of employment.

### SUMMARY

The disclosure is directed at a method and system for determining an adaptability quotient (AQ) index. In some embodiments, the AQ score or index is used by people, such as, but not limited to, human resources individuals, academic counsellors, hiring managers or people looking to match applicants with available employment opportunities and the like. The AQ index may also be used to measure and demonstrate skills and skill-gap opportunities as an individual plans for next-career moves or transitions. The AQ index may be seen as an index to determine the suitability of an individual for a position of employment or an index to determine the types of employment that may be suitable for an individual.

In one aspect of the disclosure, there is provided a method for determining an adaptability quotient (AQ) index for an individual including calculating the AQ index based on results to a set of assessments that have been completed by the individual; wherein calculating the AQ index includes retrieving a set of assessment scores associated with the individual; applying a weighting factor to each of the assessments scores; and calculating a sum of the weighting factored assessment scores; dividing the sum by a number of assessments; wherein the set of assessments include assessments directed at functional skills, soft skills or functional and soft skills.

In another aspect, the assessments directed at functional skills include reading assessments, numeracy assessments, problem solving assessments, digital competency assessments and technical competency assessments. In a further aspect, the assessments directed at soft skills include emotional intelligence assessments, an OCEAN-Personality assessment, social and emotional learning assessment or an adaptability skills assessment. In yet another aspect, the AQ index is represented as:

$$\frac{{\sum }_{i = 1}^{j} {a}_{i} {w}_{i}}{N}$$

where N is the number of assessments, aᵢ is a current assessment score and wᵢ is the weight factor for i^{th} assessment.

In a further aspect, the method further includes generating a skills profile for the individual; and calculating a set of occupational AQ scores based on the individuals skills profile. In yet a further aspect, generating a skills profile includes parsing the individual's work history to generate embeddings for each word and sentence in the individual's work history; calculating cosine similarity scores between the embeddings and a set of previously defined employment fields or opportunities; and updating individual's work history with the set of previously defined employment fields or opportunities having the highest cosine similarity score for each embedding. In yet another aspect, parsing the individual's work history to generate embeddings includes generating embeddings using a sentence-BERT framework fine-tined with multi-negative ranking loss.

### BRIEF DESCRIPTION OF THE DRAWINGS

Reference is now made to the accompanying figures in which:

FIG. 1 is a schematic diagram showing a system for determining an adaptability quotient (AQ) index in its operational environment;

FIG. 2 is a schematic diagram of a system for determining an adaptability quotient (AQ) index;

FIG. 3 is a flowchart showing a method of determining an adaptability quotient (AQ) index;

FIG. 4 is a flowchart showing a method of storing information in a database for use in determining an adaptability quotient (AQ) index; and

FIG. 5 is a flowchart showing a method of using an AQ index.

### DETAILED DESCRIPTION OF THE EMBODIMENTS

The disclosure is directed at a method and system for determining an adaptability quotient (AQ) index. The AQ index or score may be seen as a measure of an individual's or applicant's suitability for an employment opportunity or an individual's suitability for a specific employment field. The AQ index may also reflect an individual's ability to adjust to changes in work conditions and adapt to new tasks or situations. The AQ score may be used to determine which individuals may be most suited for a specific type of employment or to determine which individuals may be more suited for an employment opportunity. The AQ score may also be used to direct individuals to training or upskilling that would help improve their suitability for employment. In one embodiment, the disclosure may be used to determine a general AQ index and/or an occupation specific AQ index. The overall or general AQ score measures or represents an individual's ability to adapt to general vocational challenges and the occupation specific AQ score measures or represents an individual's ability to adapt to and fulfil the expectations of a specific occupation or employment field.

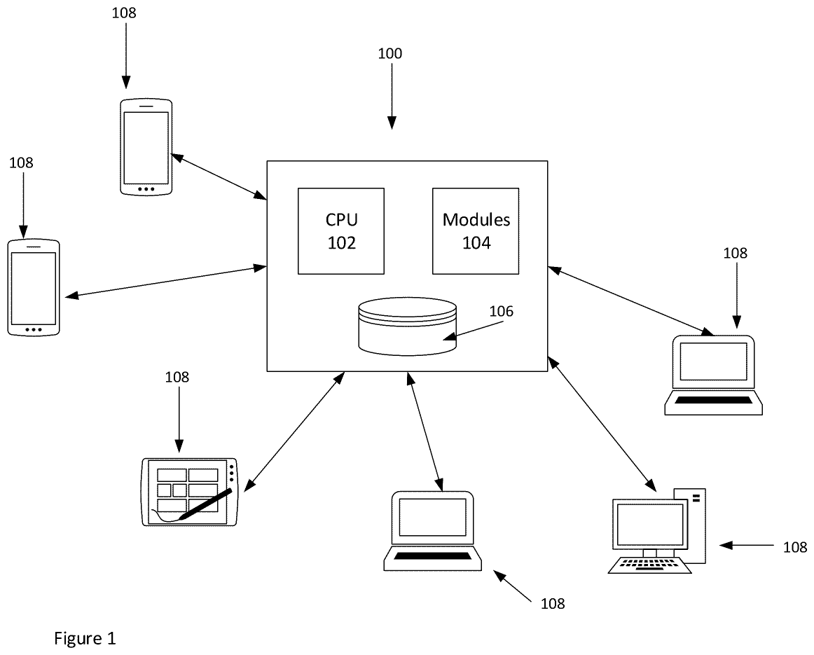

Turning to FIG. 1, a schematic diagram showing a system for determining an adaptability quotient (AQ) index in its operational environment is shown. The system 100 includes a processor or central processing unit (CPU) 102 along with a set of modules 104 that perform different functionality to implement the system for determining the AQ index or score 100. The system 100 may further include a database 106 for storing information, such as, but not limited to, a set of AQ indexes that are associated with users of the system. In some embodiments, the database 106 may be part of the system 100 and in other embodiments, the database may be external to the system. The database 106 may also store other information such as, but not limited to, user demographics or user information, educational history, current and previous occupations, professional certificates, assessment results from skills assessments and other user information. The skills assessments relate to assessments or determinations of functional skills or soft skills that a user might have. Examples of functional skills include, but are not limited to, reading, numeracy, problem solving, digital competency and/or technical competency while soft skills may include, but are not limited to, emotional intelligence, an OCEAN-Personality test or score, social and emotional learning and/or an adaptability skills assessment.

In operation, the system 100 is in communication with a set of communication devices 108 associated with or used by different users of the system 100. These users may include applicants looking for positions of employment, academic counsellors, recruiters, supervisors, human resources personnel and the like. The communication devices 108 may include, but are not limited to, tablets, smartphones, laptops, desktop computers and the like. Communication between the communication devices 108 and the system 100 may be over a public network, such as the Internet, or a private network, such as within an academic institution, using known communication protocols.

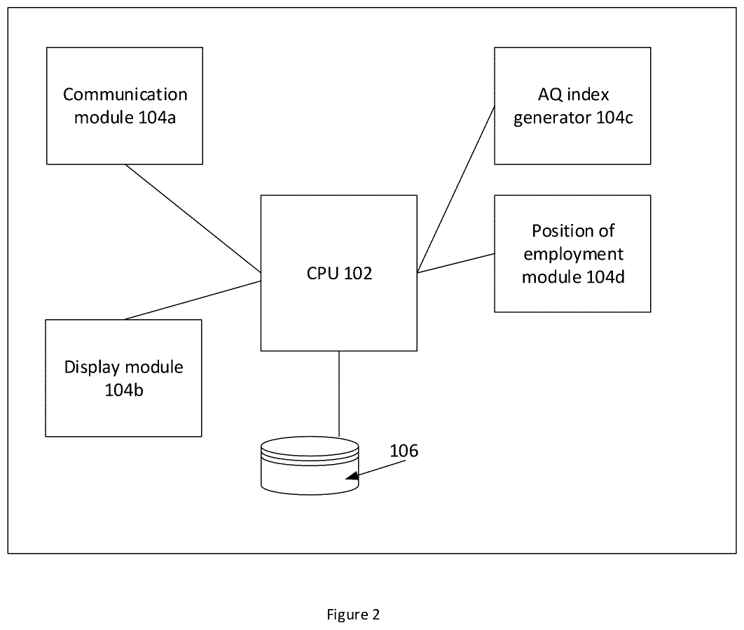

Turning to FIG. 2, a schematic diagram of the system 100 is shown. As described above, the system 100 includes the set of modules 104 for performing the functionality of determining an AQ index for a user. The set of modules 104 includes a communications module 104a, a display module 104b, an AQ index generator module 104c and a positions of employment module 104d. The positions of employment module 104d may be seen as a component which outlines skills required for specific employment roles contrasted against skills the individual has demonstrated via assessment results, work and education experience.

The communications module 104a provides the functionality enabling the system 100 to communicate with the communication devices 108, database 106, external servers (not shown) or external databases to transmit and receive digital data. The communication module 104a may also store information to and retrieve information from the database 106.

The display module 104b provides the functionality to generate images or screens that are displayed on the communication devices 108. For example, the display module 104b may receive the AQ index from the AQ index generator module 104c and then provide a display that may be communicated to the communication device 108 via the communication module 104a so that a user can review the AQ index or information on their associated communication device 108. In some embodiments, the system may know the type of communication device 108 and the display module 104b generates a display that is compatible with the communication device 108.

The AQ index generator module 104c performs the functionality to calculate either a general AQ index, an occupation specific AQ index or both as will be described in more detail below. The positions of embodiment module 104d performs the functionality to determine which employment fields or positions an individual is suited for based on assessments that have been completed by a user or based on the calculated general and/or occupation specific AQ index(es).

As schematically shown in FIG. 2, the CPU 102 is connected to each of the modules 104 and the database 106. Although not shown, the modules 104 may be connected to, or communicate with, the database 106 directly as well or with each other.

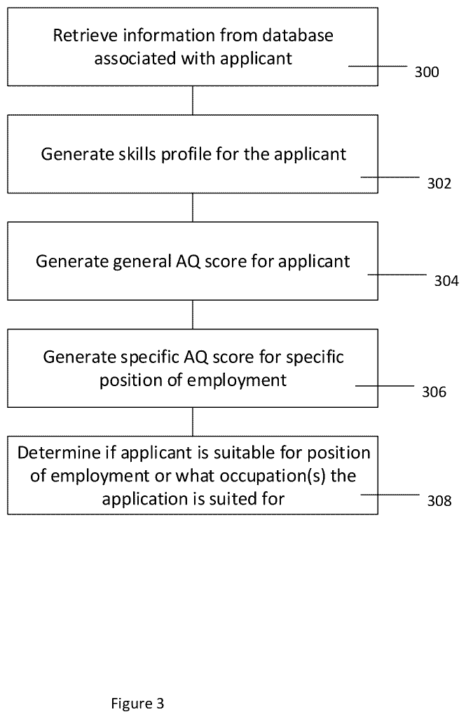

Turning to FIG. 3, a flowchart showing a method of determining an AQ index is shown. In some embodiments, the method is performed by the AQ index generator module 104c. It is assumed that the database 106 has been pre-filled and stores various digital information or digital data such as, but not limited to, user identification information, user work history, user education history, different types of available occupations, previously completed user assessments, skills and competencies required for roles or job positions and/or labor market information for roles. It is understood that in one embodiment, the system is initiated by an individual requesting an AQ index for one of the users who may be seen as an applicant or person of interest. The individual requesting the AQ index may be the applicant, may be a user trying to assist the applicant in obtaining employment or may be a user interested in determining if the applicant is a match for an employment opportunity. The calculated AQ index (which may be the general AQ index and/or the occupation specific AQ index) represents an understanding of skills and contexts that are required for success for the job or employment opportunity and the overall ability of the applicant to adapt to new contexts for success in prospective employment opportunities.

Initially, the system retrieves information from the database related to the applicant or person of interest (300). In some embodiments, the system retrieves applicant work history or an applicant experience (i.e. work) profile and results from any previous skills assessment associated with the applicant. The system may also retrieve applicant identification information to confirm that the retrieved information is associated with the person of interest. The system may retrieve this information from database 106 or from an external server or database in communication with system 100, such as via the communications module 104a.

After retrieving the information, the system then generates a skills profile (302) for the applicant that is based on the retrieved information. The skills profile may represent the applicant's skill across the different employment domains as measured by the assessments and the applicant's work history. In some embodiments, the skills profile may be generated based on a combination of the work experience profile and information from online occupational data or databases.

In one embodiment, the system may use natural language processing (NLP) to parse the retrieved information to match the applicant's work or employment history with previously defined employment designations or domains or standardized/normalized employment or occupations. For example, previously defined employment designations may include accountant, engineer, computer programmer, sales and the like. As different terms or definitions may be used in the applicant's work history, parsing of the applicant's work history enables the system to associate the applicant's work history with predefined employment designations to facilitate determination of the general AQ index and/or the occupation specific AQ index. For example, the applicant's work history may include the term “retail employee” which may be parsed to be equivalent to “sales associate” such that the system normalizes the applicant's retail work experience to the previously defined employment designation of sales.

In some embodiments, the system may request the applicant to submit responses to assessments that are provided by the system to provide further analytics or data points. In some embodiments, the system may transmit unfinished assessments (assessments previously started by an applicant but not completed) to the applicant for completion. The completed assessments are received by the system and stored in the database.

The system then generates a general AQ score for the applicant (304) based on the skills profile that was generated in (302) for the applicant. In some embodiments, the general AQ score is calculated or generated based on the assessment results. In one embodiment, the general AQ index is generated by combining the individual's functional skills assessment scores (e.g. reading, numeracy, digital competencies and/or problem solving) and/or soft skills assessment scores (e.g. OCEAN personality, ACER social & emotional learning and/or emotional intelligence) and adaptability. In one embodiment, the general SAQ index is calculated by combining or summing the assessment scores and then dividing the sum by the number of assessments to arrive at a weighted average.

In one embodiment, each of the assessments are measured on a continuous scale from 0 to 100. An example general AQ index equation can be represented as:

$$\frac{{\sum }_{i = 1}^{j} {a}_{i} {w}_{i}}{N}$$

where N is the number of assessments, aᵢ is the current assessment score and wᵢ is the weight of the i^{th} assessment. It is understood that the weighing factor for each of the assessments is based on its requirement with respect to the employment opportunity. For example, some skills such as problem-solving and emotional intelligence may have a broader impact on an applicant's overall employability and therefore a higher weighting factor may be applied to the applicant's skills assessment scores for these areas. As understood, in some embodiments, the system determines the assessment weighting for each different employment field or domain based on previous general AQ index determinations or based on a predetermined set of weighting factors that are predetermined for each employment field or domain.

The reading assessment may be seen as an assessment that tests the applicant's ability to understand and work with written information and, in some embodiments, the reading assessment may align with the Government of Canada's Skills for Success Framework. The numeracy assessment may be seen as an assessment that tests an applicant's ability to understand and use mathematical information in different situations and, in some embodiments, the numeracy assessment may align with the Government of Canada's Skills for Success Framework. The problem-solving assessment may be seen as an assessment that tests an applicant's ability to identify, analyze, propose solutions, and make decisions and, in some embodiments, the problem-solving assessment may align with the Government of Canada's Skills for Success Framework. The digital competency assessment may be seen as an assessment that tests an applicant's ability to use digital technology and tools and, in some embodiments, the assessment may align with the Government of Canada's Skills for Success Framework. The ACER assessment may be seen as a social and emotional learning assessment that tests an applicant's ability to either acknowledge and know their own emotions; control their emotions; have empathy and social awareness and/or build and maintain relationships. The emotional intelligence assessment maybe seen as an assessment that tests an applicant's abilities in at least one of emotional perception; emotional understanding; emotional management; teamwork and/or creativity. The OCEAN assessment may be seen as a personality assessment that provides insights into at least one of an applicant's openness, consciousness, extraversion, agreeableness, and impression management.

After the general AQ score or index has been generated or calculated, the system may then generate or calculate an occupation or employment specific AQ index associated with a predetermined or selected occupation or available position of employment (306). In some embodiments, the predetermined or selected occupation may relate to an actual employment opportunity to determine if the applicant is suited for the employment opportunity. Alternatively, one or more occupation specific AQ score(s) may be calculated based on employment field reflected by the general AQ index. In some embodiments, the occupation specific AQ score may be calculated based on the applicant's skills profile (as described above), assessment results and online occupation data or databases.

After calculating the general AQ index, the system may then update the skills profile generated above. In other embodiments, the skills profile that was generated in (302) may not be generated until after the general AQ index (based on the assessments) is generated or calculated by the system in (304). In other words, (302) may occur before or after (304).

In another embodiment of generating a skills profile, when work history is entered into the system, the applicant is prompted to normalize or assign their previous work experience to previously defined employment designations that are listed or stored in the system. In one embodiment, this may be performed by generating embeddings for each word and sentence in the applicant's work history or work experience and comparing those with embeddings or the previously defined employment designations.

In one specific embodiment, the generation of embeddings is performed using a model called Sentence-BERT framework (all-mpnet-based-v2) that is fine-tuned using Multi-Negative Ranking Loss (MNRL) based on predetermined occupation data. The embeddings are then used to calculate cosine similarity scores between the parsed terms from the applicant's work experience and the previously defined employment designations. The use of cosine similarity is used to infer semantic similarity. A predetermined number, such as but not limited to five (5) occupations with the highest cosine similarity are then presented to the applicant so they can select the closest matching occupation to their work experience. For example, if the system generates an embedding of “sales” for an applicant's retail employee work experience, after cosine similarity is performed, the system may display “medical sales”, “retail sales”, “engineering sales”, “travel agent” and “software sales” for the applicant to select the occupation best representing their retail employee work experience.

After selecting the previously defined employment designations that align with the applicant's work history, the previously defined employment designations are used to build or update a baseline skills profile for the applicant for each of the selected occupations. It is understood that each of the previously defined employment designations have pre-determined skills associated with the previously defined employment designations. The skills and skill values related to the selected or assigned occupation form the starting point for generating or updating an applicant's skills profile for that occupation.

Once an individual has selected or assigned an occupation or previously defined employment designation for each of their work experiences, the system then combines the skills profile for each individual occupation to form or update an overall skills profile for the user.

In one embodiment of generating a skills or occupation AQ index, a recency decay value and a duration decay value for the selected occupation are calculated. These two values represent or measure how skill scores should be adjusted based on how long it has been since the applicant has worked at the selected occupation and how long the applicant was working at the selected occupation.

To calculate the recency decay value, a recency value (representing how long ago the applicant worked at the selected occupation) is calculated. In one embodiment, the recency value is calculated using the following equation:

$$recency = ( currentYear - endYear ) + \frac{( currentMonth - endMonth )}{12}$$

where currentYear is the current year; endYear is the year the applicant finished working at the selected occupation, currentMonth is the current month and endMonth is the month the user finished working at the selected occupation. In some embodiments, a maximum recency time or maximum recency value can be set or applied and if the calculated recency value exceeds

$$recencyDecay = ( 1. - ( \frac{recency}{maxRecencyTime} ) ) * ( 1. - minRecencyDecay ) + minRecencyDecay$$

the maximum recency time value, the recency decay value is set to equal the maximum recency time value. Otherwise, the recency decay value is calculated using the following equation:

where maxRecencyTime is largest recency penalty and minRecencyDecay is the minimum or low recency decay value.

To calculate a duration decay value, the duration of time spent in the selected occupation is calculated using the following equation:

$$durration = ( endYear - startYear ) + \frac{( endMonth - startMonth )}{12}$$

where endYear is the year the applicant finished working at the selected occupation, startYear is the year the applicant started working at the selected occupation, endMonth is the month the applicant stopped working at the selected occupation and startMonth is the month the applicant started working at the selected occupation.

If the calculated duration value is larger than or equal to a maximum duration time value, the duration decay value is set to 1.0. Otherwise, the following equation is used to calculate the duration decay value:

$$durationDecay = {log}_{( maxLogX + 1 )} \frac{( maxLogX * duration )}{maxDurationTime} + 1$$

where max Log X is a factor used to rescale the logarithmic function so that its domain and range are adjusted so the output is in the range [0, 1], and maxDuration Time is the maximum or a that duration time that is set or configured.

Overall decay for the selected occupation can then be calculated using this equation:

$$decay = recencyDecay * durationDecay$$

The overall decay value is then used to calculate an adjusted skill value for each of the skills in the selected occupation. This may be performed by multiplying the base skill value with the decay value. The skills between selected occupations are then combined into a weighted sum so that there is one skill score per skill per applicant. This is done first by calculating an occupational skill weight using this equation:

$$occupationSkillWeight = {duration}^{weightedExponent}$$

where weightedExponent is a scaling factor used for calculating occupationSkillWeight. A skill value for each separate skill can be calculated using the skill values from each selected occupation using the following equation:

$${\sum }_{i = 1}^{n} {skillValue}_{i} * \frac{{occupationSkillWeight}_{i}}{totalWeightOfSkill}$$

where skillValue is the adjusted skill value from an occupation, i is the i^{th} occupation, occupationSkillWeight is the weight for the specific occupation and totalWeightOfSkill is the sum of all the weights between occupations. The above equation is calculated for every individual skill that has a value from one of the applicant's occupation choices. The skill value may be obtained from the user's skill assessment score.

For example, for a skill “problem-solving”, any occupation job identified in the applicant's experience that is associated with a skills assessment “problem-solving” score would be included in this calculation.

The skills profile may then be refined using the applicant's results from the assessments. For example, if the baseline skills profile of an applicant indicated that they had a 66% in mathematics, but they completed the numeracy assessment and scored a 78%, the applicant's mathematics skill may or could be adjusted to 78%. As such, the assessments help measure specific skills directly and then adjust skills within the applicant's skills profile.

An individual can now select an occupation to see their occupation specific AQ score related to that occupation. This score may be determined as an average of the skills scores of the applicant's skills and the skill scores required for the selected occupation. In one embodiment, the equation for the specific AQ score may be represented as:

$$SpecificAQScore = \frac{\begin{matrix}{\sum }_{i = 1}^{n} ( min [ ( \frac{{uSkill}_{i}}{{oSkill}_{i}} ) , maxSkillMatch ] ) - \\ ( {\sum }_{x = 1}^{m} missingSkillConstant * \frac{oSkillx}{100} )\end{matrix}}{n}$$

where i is the i^{th} skill, n is the number of required skills for the occupation, uSkillᵢ is the i^{th} skill from the user profile, oSkillᵢ is the i^{th} required occupational skill value, maxSkillMatch is a constant set to minimize or reduce the effect of user skills that over match the occupational requirement, x is the x^{th} missing skill that is required for the occupation, m is the number of missing skills from the users profile, missingSkillConstant is a constant set as a penalty for missing a required skill, and oSkillx is the x^{th} skill that is required for the occupation but is missing from the user's skills profile.

In other embodiments, the specific AQ index may be used to indicate the types of occupation or careers in which the applicant may be suited for. In these embodiments, the specific AQ score may be compared with threshold scores associated with occupations or careers and if the AQ index or score matches or exceeds the threshold score, the system may determine that the applicant is suitable of employment in those occupations or careers (308). In another embodiment, these thresholds may be used to show “stretch” careers that represent upward mobility in their employment. These “stretch” careers may include careers with additional compensation that the user may be a close match too, or with small improvement in some skill areas they would be a close match too.

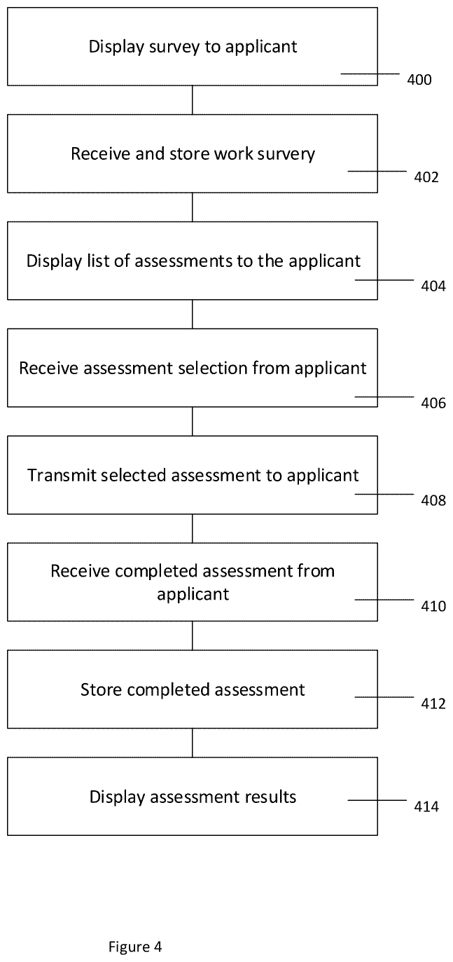

Turning to FIG. 4, a flowchart showing how information may be stored within a database is shown. This may be seen as the tasks that are performed prior to the method of FIG. 3 being executed to determine a general and/or specific AQ score or index. It is assumed that the user or applicant has previously signed up or registered with the system and has been authenticated into the system. The registration of a user within a system and the components of a system to authenticate users when logging into the system will be understood.

Initially, the applicant is provided a survey or questionnaire by the system (400) that is directed towards the applicant's work history. Upon completion of the survey, the applicant can submit the completed survey including the work history information which is then received and/or stored by the system (402) such as within the database. In some embodiments, the applicant may submit their work history via other methods, such as, but not limited to, the submission of a curriculum vitae or resume which is parsed by the system.

The system then provides a list of different assessments (404) for the applicant to review and select (406). The assessments may be based on the soft and/or functional skills assessments as outlined above. The system then provides the selected assessment to the applicant (408) for completion and receives the completed assessment (410) and then stores the completed assessment (412) with the necessary identification information associated so that it will be associated with the applicant. It is understood that more than one assessment may be selected for completion and that (404) to (412) may be performed multiple times. If required, the system may also display the assessment results to the applicant (414).

If the applicant decides they do not want to fill out an assessment or has completed all assessments they wish to complete, the system may ask the applicant if they wish to see their general AQ score which results in the system performing the method taught in FIG. 3 with respect to the general AQ index calculation. In this case, it is assumed that the applicant has previously completed at least one assessment whereby the system has been able to calculate at least a general AQ score.

The system may then display the applicant's general AQ score along with their work history and any previous assessment results. The system may then ask the applicant if they wish to see occupation specific AQ scores. If so, the applicant is asked which occupation they are interested in and the system calculates the occupation specific AQ score (also from FIG. 3).

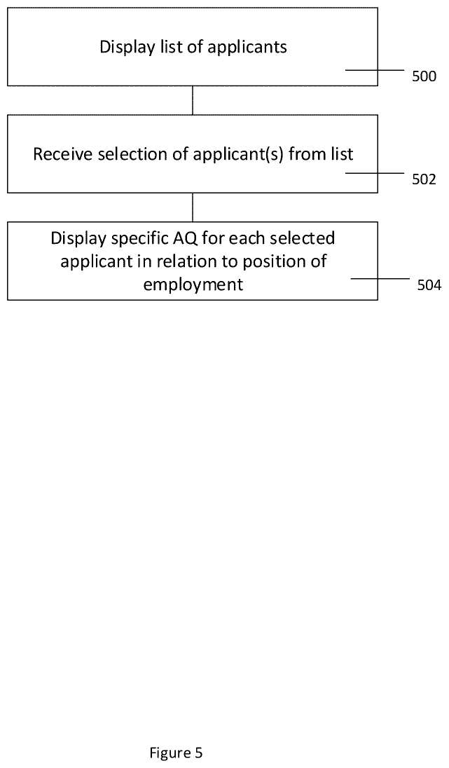

Turning to FIG. 5, a flowchart showing tasks that can be performed after the AQ scores (either or both general and occupation specific) are calculated is shown. In one embodiment of the flowchart, the tasks are directed at enabling an individual, such as, but not limited to, a human resources manager to review applicant AQ scores with respect to available positions of employment or employment domains.

After calculation of a general AQ score (and at least one occupation specific AQ score), the system may display a list of applicants to a human resources manager (500) based on AQ scores that meet a threshold value. The list of applicants may be a list of all the applicants in the system or may be a list of applicants that may be suitable for a specific position of employment. The human resources manager may then select at least one applicant to view their AQ score with respect to a specific position for employment (502). The system then displays at least one of the general and/or occupation specific AQ score for an applicant along with their work history (504). The human resources manager can then use this information to determine which applicant, if any, should be matched with the position of employment.

The methods and systems described herein may be implemented in a high level procedural or object oriented programming or scripting language, or a combination thereof, to communicate with or assist in the operation of a computer system. Alternatively, the methods and systems for upgrading at least one seat may be implemented in assembly or machine language. The language may be a compiled or interpreted language. Program code for implementing the methods and systems for upgrading at least one seat may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems for upgrading at least one seat may also be considered to be implemented by way of a non-transitory computer-readable storage medium having a computer program stored thereon. The computer program may comprise computer-readable instructions which cause a computer, or in some embodiments the processing unit, to operate in a specific and predefined manner to perform the functions described herein.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure.

Various aspects of the methods and systems for upgrading at least one seat may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be obvious to those skilled in the art that changes and modifications may be made without departing from this invention in its broader aspects. The scope of the following claims should not be limited by the embodiments set forth in the examples, but should be given the broadest reasonable interpretation consistent with the description as a whole.

What is claimed is:

1. A method for determining an adaptability quotient (AQ) index for an individual comprising:
calculating the AQ index based on results to a set of assessments that have been completed by the individual;
wherein calculating the AQ index includes:
retrieving a set of assessment scores associated with the individual;
applying a weighting factor to each of the assessments scores; and
calculating a sum of the weighting factored assessment scores;
dividing the sum by a number of assessments;
wherein the set of assessments include assessments directed at functional skills, soft skills or functional and soft skills.

2. The method of claim 1 wherein the assessments directed at functional skills comprise reading assessments, numeracy assessments, problem solving assessments, digital competency assessments and technical competency assessments.

3. The method of claim 1 wherein while the assessments directed at soft skills comprise emotional intelligence assessments, an OCEAN-Personality assessment, social and emotional learning assessment or an adaptability skills assessment.

4. The method of claim 1 wherein the AQ index is represented as:
$$\frac{{\sum }_{i = 1}^{j} {a}_{i} {w}_{i}}{N}$$
where N is the number of assessments, aᵢ is a current assessment score and wᵢ is the weight factor for i^{th} assessment.

5. The method of claim 1 further comprising:
generating a skills profile for the individual; and
calculating a set of occupational AQ scores based on the individuals skills profile.

6. The method of claim 5 wherein generating a skills profile comprises:
parsing the individual's work history to generate embeddings for each word and sentence in the individual's work history;
calculating cosine similarity scores between the embeddings and a set of previously defined employment fields or opportunities; and
updating individual's work history with the set of previously defined employment fields or opportunities having the highest cosine similarity score for each embedding.

7. The method of claim 6 wherein parsing the individual's work history to generate embeddings comprises:
generating embeddings using a sentence-BERT framework fine-tined with multi-negative ranking loss.

8. A method of determining an occupation specific adaptability quotient (AQ) index for an individual comprising:
retrieving a work history of the individual, the work history including a list of occupations held by the individual;
matching each of the list of occupations held by the individual with a predetermined list of standard occupations;
calculating a recency decay value and a duration decay value for each of the list of occupations held by the individual with respect to each matched occupation from the predetermined list of standard occupations;
applying the recency decay value and the duration decay value to a skill score for each of the list of occupations held by the individual to determine individual and skill specific scores for each of the list of occupations held by the individual; and
calculating the occupation specific AQ index based on the individual and skill specific scores for each of the list of occupations held by the individual.
